(19) United States
(12) Patent Application Publication
(10) Pub. No.: US 2011/0025911 A1
(43) Pub. Date: Feb. 3, 2011

(54) Method of enhancing motion pictures for exhibition at a higher frame rate than that in which they were originally produced

(76) Inventor: Robert C. Weisgerber, New York, NY (US)

Correspondence Address: DAVID PETER ALAN, ESQ., 81 Second St., South Orange, NJ, 07079, US

(21) Appl. No.: 12/806,549

(22) Filed: Aug. 16, 2010

Related U.S. Application Data
(63) Continuation-in-part of application No. 11/478,940, filed on Jun. 30, 2006.
Application No. 11/478,940 is a continuation-in-part of application No. 10/846,611, filed on May 17, 2004, now abandoned.

(51) Int. Cl. H04N 7/01; G03B 21/32

(52) U.S. Cl. 348/448; 352/38; 348/E07.003

(57) ABSTRACT

Previously-produced motion pictures are enhanced for theatrical exhibition, at double the frame rate at which they were originally produced. Synthesized images are interpolated between each of the images of the original motion picture. These interpolated images are generated through the use of computer software that analyzes the actual horizontal and vertical displacement of each pixel of every image of the original motion picture, so the interpolated images accurately depict the exact image that would have been captured, if the original motion picture had been produced at double the actual frame rate of production. This enhancement technique can be used selectively for certain scenes or sequences. The invention uses the 70 mm film format or digital equivalent, with picture information added to films produced in a 35 mm format. For image components containing complex motion, those components are selected for treatment to correct for such complexity. The entire process can be executed automatically.

This application is a continuation-in part of application Ser. No. 11/478,940, filed Jun. 30, 2006, which is a continuation-in-part of application Ser. No. 10/846,611, filed May 17, 2004 and now abandoned.

### FIELD OF THE INVENTION

This invention relates to the enhancement of previously-produced motion pictures for exhibition to audiences in motion picture theaters, with upgraded quality of presentation, compared to that obtainable from the motion pictures as originally produced.

### BACKGROUND OF THE INVENTION

Most motion pictures produced for conventional theatrical exhibition are photographed at the speed of twenty-four frames per second, a frame rate that has been in use for most of the history of cinema. At that frame rate, there persist undesirable artifacts that detract from the appearance of reality that is one of the goals of modern motion picture production. Films shot and presented at that rate have flicker, perceptible grain, motion artifacts and an appearance that lacks immersive character. This latter artifact is particularly objectionable on large theater screens (fifty feet or more in width), since any image component must move a greater physical distance between discrete images on a large screen than on a smaller screen.

Films shot at higher frame rates succeeded, to some extent, in suppressing this undesirable artifact. Cinerama (three synchronized filmstrips photographed and projected at twenty-six frames per second, primarily used for travelogues) was somewhat successful in reducing flicker. The original Todd-AO system utilized actual photography at thirty frames per second, in addition to the conventional twenty-four frames per second. A few motion pictures, including Oklahoma and Around the World in Eighty Days, were produced in that format. However, the use of separate photography at two different frame rates was costly, and few films were produced in the Todd-AO format. More recently, the inventor herein taught a means for transitioning between film sequences photographed for exhibition at twenty-four frames per second and other sequences photographed at thirty frames per second between scenes of a single motion picture (U.S. Pat. No. 5,096,286 (1992)). While there was a perceptible improvement in smoothness of motion at the higher frame rate, the latter system was never developed commercially.

More recently, Weisgerber has taught the use of forty-eight frames per second as a rate for photographing and showing motion pictures, to develop a presentation that suppresses the undesirable artifacts present at twenty-four frames per second (U.S. Pat. No. 5,627,614 (1997)). In that invention, certain sequences or certain image components are photographed at forty-eight frames per second, for a “high-impact” presentation. Other sequences or image components are photographed at twenty-four frames per second and double-frame printed, to retain the artifacts that gave the film the “legacy” look. With the entire motion picture produced according to that invention projected at forty-eight frames per second, it became possible to give certain portions of a motion picture film or certain image components a more realistic look, compared to other portions of the film or other image components. In order to deliver the full impact to the audience, the preferred embodiment of that invention used a large format, such as 70 mm theatrical format, equivalent to eight perforations high, with images anamorphically squeezed onto the conventional 70 mm (five-perforation) format for storage on the film reel, and stretched to the eight-perforation aspect ratio upon projection in the theater.

The previously-mentioned invention only works optimally in films produced according to it. This means that it only delivers the full audience effect in new films. For motion pictures already in existence, whether photographed on film or through digital image capture, the full effect can only be delivered if those motion pictures are enhanced and converted for projection at a frame rate of forty-eight frames per second or higher. Most commercially produced films, including IMAX films, are photographed at twenty-four frames per second. Today, most commercial films are photographed in the 35 mm feature film format, with four perforations per frame. That format does not allow for sufficient visual information storage to deliver the full effect of the previous Weisgerber invention, which requires the 70 mm film format or comparable digital cinema format for the full desired effect. Films produced in the 35 mm format can be converted to the 70 mm format for this purpose. Most importantly, twenty-four discrete images each second are not enough to provide for the smooth appearance of motion delivered by the previous Weisgerber invention. Additional images must be added and, unfortunately, analog film methods also add undesirable amounts of jutter and blurring to the transitional “in between” images that are synthesized through conventional image compositing.

The invention disclosed here is resolution-independent, in that it can be used in connection with any resolution level presented to the viewers of a motion picture, including newly-developed high-resolution formats.

Smoothness of motion, as seen by the audience, is especially important in modern motion picture theaters. Their screens are, in many cases, fifty feet or more in width. Any finely-delineated motion projected onto such a wide screen must traverse a greater distance on that screen between images than is traversed on older screens, which were seldom over forty feet wide. In order for motion to appear smooth when displayed at forty-eight frames-per-second, it is necessary to add an extra image between each of the original images of a motion picture. This way, the large distance displaced by each picture element (pixel) from one image to the next does not impart a jerky appearance to the motion picture as projected. The present invention solves this problem by using technology originally designed for a different purpose, as shall be shown.

As Weisgerber 614 teaches, motion picture feature films photographed and projected at forty-eight frames per second convey a significantly more realistic presentation of motion than do films photographed and projected at twenty-four frames per second (conventional frame rate). This difference accounts, in large part, for the novelty of Weisgerber 614 and his subsequent invention, U.S. Pat. No. 5,739,894 (other frame rates). Actual photography at forty-eight frames per second or a higher frame rate delivers an improved presentation compared to twenty-four frames per second, but only newly-produced films can be photographed at that rate. For previously-produced films, or for films which could not be feasibly photographed at a high frame rate, enhancement of images captured at the rate of twenty-four frames per second is required. This is also true for digital cinematography at twenty-four images captured per second.

It is the primary objective of this invention to produce such image enhancement. The purpose of this enhancement is to allow for the release of motion pictures that contain images that will appeal to contemporary audiences, although the motion pictures themselves depict action that occurred and had been photographed in the past.

It should be noted that other inventions have used variable frame rates for storage of digital motion picture images; see, e.g. Cok (US2003/0016750), which teaches a method for storing such images at different frame rates for economy of storage resources. The present invention goes beyond the teachings of Cok to correct difficulties encountered in the image enhancement process that would otherwise defeat the method described here. In short, the Cok invention teaches a method for compression of existing digital image data. The present invention, in contrast, teaches a method for expansion of existing data; specifically producing new frames for interpolation between pre-existing frames for the enhancement of a motion picture presentation.

In practice, the Cok invention is inadequate to deliver the sort of immersive audience experience that is the object of the present invention. Cok's purpose is not to develop new “in-between” images to enhance presentation, but merely to store images efficiently. A different method is required to produce new images that meet contemporary presentation standards, unhampered by artifacts. Software specifically developed to speed up motion for special effects purposes is also too rudimentary for the purpose of the present invention; further image treatment is needed to produce a high-quality image for presentation.

Even if the method taught by Cok were used for the purpose of the present invention, it would not succeed in delivering an appropriate cinema presentation, free of artifacts. The mere use of variable frame rates, as utilized for slow-motion effects, is unsuitable for a high-impact presentation. One of the primary deficiencies of the prior art is that existing variable frame-rate methods are not capable of dealing effectively with complex motion, so that such motion could be presented to an audience in a form that is free of undesirable artifacts. By using software that “looks ahead” to place each pixel of each image in its proper position, the invention goes beyond the prior art and overcomes this deficiency.

Similarly, software that was originally designed to produce slow-motion effects can generate the “in-between” images that are interpolated between each of the original images in the practice of the invention. However, the inherent limitations of the software when used in the conventional manner limit its ability to produce the high-quality images which contemporary exhibition requires. This situation presents an inherently undesirable artifact, and the invention includes a means for correcting it. This correction feature, which is an integral part of the invention described here, could not have been anticipated by the prior art.

The present invention presents the appearance of “immersive”, high-impact motion pictures by enhancing previously-produced motion pictures to replicate the image quality typically associated with advanced motion picture technology. By using contemporary computer techniques, motion pictures that actually captured motion at the rate of twenty-four frames per second can be enhanced to appear as though the motion had, instead, been captured at forty-eight frames per second. This allows release of previously-produced motion pictures, with an image quality that will satisfy contemporary audiences. Thus, the motion pictures treated according to this invention can generate a new revenue stream for their owners.

### BRIEF DESCRIPTION OF THE INVENTION

The invention described here is a method for enhancing existing films or motion pictures photographed in a digital format, so that they can be shown according to the invention previously taught by Weisgerber, in a manner that delivers a high-impact presentation. The invention uses the 70 mm film format, with five perforations per frame in the preferred embodiment, although digital projection in a comparable format is also suitable. Since nearly all films that were ever commercially produced were photographed at twenty-four frames per second, the primary objective of the invention is to enhance films originally photographed at that frame rate, so that they can be projected at forty-eight frames per second with the quality of presentation that only the higher frame rate can deliver.

Mere projection at the higher frame rate cannot be done with analog film technology, except by double-frame printing. Double-frame printing cannot realistically simulate the motion that the camera would have captured if the film in question had actually been photographed at a higher frame rate. However, such realistic motion can be simulated using computerized techniques originally designed to generate additional frames to create slow-motion effects. The present invention goes far beyond the mere interpolation of extra frames, as will be explained.

There have been other methods taught in the prior art for creating new images to be interpolated between each image of the original motion picture and the next successive image of the original motion picture. In one such method, pseudo-images were synthesized by combining the previous and successive images, as if each “in-between” image were intended to look like a dissolve between the previous and next images. This method produced objectional artifacts for the viewers of the motion picture; particularly motion blur. The present invention solves this problem by synthesizing discrete images that accurately depict the motion that would have been captured originally, if capture had taken place at twice the frame rate that was actually employed.

In the practice of the invention, motion picture films that have already been photographed and produced for public exhibition are first digitized by conventional means known in the art; a step not required for motion pictures photographed by digital means. Then computerized techniques are used to produce new images for interpolation between each successive pair of original images. In this manner, the number of images is doubled, so the resulting motion picture can be projected at forty-eight frames per second to deliver forty-eight discrete images every second. These motion pictures can be shown either through conventional projection, or through digital exhibition methods, as known in the art. For conventional projection, they are converted back to an analog “film” form, also through means known in the art. In addition, a means for dealing with highly complex motion that could not otherwise be processed by conventional use of the computer software is included as part of the invention.

In the present invention, software is used to produce a transitional “in-between” image for interpolation between each pair of successive images in the original motion picture. Mere interpolation of an image that appears “half way between” the previous image and the next image (positioned with respect to each image to be interpolated) is not sufficient to deliver the desired effect. Instead, the software used in the invention actually analyzes the apparent motion change through each sequence to generate an image to be interpolated between each image of the original motion picture and the next image of the original motion picture. Because the original images are in digital form when the interpolated images are added, the software enables the user of this invention to control each individual pixel of every image of the entire motion picture. The software is used to produce interpolated images that would appear consistent with the motion of the objects originally photographed. The result is the depiction of what the motion picture would have looked like if twice as many discrete images were originally captured than actually were.

The computerized techniques used in this invention impart the correct amount of motion displacement to each pixel that comprises each of the images that form the motion picture subjected to this enhancement and conversion method. Through this technique, films that were actually photographed at twenty-four frames per second will appear as if they had originally been photographed at forty-eight frames per second. Films originally produced in the 35 mm format can also be converted to the 70 mm format, or its digital equivalent, by adding sufficient visual information to fully exploit the resolution available with the 70 mm film format. In the practice of the invention, information is added to the original motion picture in four ways. First, grain is removed, if required, thereby reducing “noise.” Next, “in-between” images are created and interpolated using motion vectoring, which adds the necessary visual information. Then, motion blur is reduced, if desired. Finally, the image is sharpened, again if desired. The removal of these artifacts dramatically improves the appearance of the motion picture enhanced by this invention. In effect, these artifacts create a veil that reduces the perception of realism that the viewer of the motion picture experiences. The process described in the present invention “removes the veil” to provide an immersive experience comparable to viewing real life.

Moreover, computer-generated images can be added selectively, only to certain scenes or sequences in a motion picture originally produced at twenty-four frames per second and converted for presentation at forty-eight frames per second in the manner described here. Under this option, other scenes would not be altered and would be double-frame printed, or its digital equivalent, for projection of the entire motion picture at forty-eight frames per second. In other words, the added realism that stems from the motion vectoring accomplished by the software used in the invention would be imparted to certain scenes or sequences of a motion picture and left out of other scenes or sequences. This allows the filmmaker to control whether or not the artifacts that deliver the “legacy” look (such as motion blur) are actually suppressed in any specific scene of a motion picture. For example, an action scene would be enhanced for high-impact presentation, while a scene where characters are holding a conversation would retain a “legacy” look. This is a feature of the cinema experience not available with conventional film methods, and only disclosed previously by Weisgerber for new films produced specifically to deliver this effect. Until the present invention, this effect was not available with any motion pictures that had previously been produced.

Some scenes capture such complex motion that the software used in the practice of the invention is unable to keep accurate track of the movement of each pixel of each image over time. An additional feature of the invention is a means to compensate for this inability by over-writing the purpose of the software for selected portions of a specific series of motion picture images, while enabling the software to continue performing its normal function for all other portions of the affected images, as well as for all other images.

The software used in the practice of the invention recognizes the path that each individual pixel of each image is taking at any time, effectively treating each pixel as a vector, whose direction is subject to change with each image of which it is a component. In doing so, the software is capable of “looking ahead” for several frames to chart the path that each pixel is taking. Because of this feature, the software is also able to recognize when the motion of certain objects within an image is too complex to be charted in this manner. In those instances, the software shifts to an operation where such specific image components from the previous original image are dropped into the synthesized “in-between” image in the same form that they had in the previous original image. This also means that the process of special treatment of such image components is done automatically, under the control of the software used in the practice of the invention.

In this manner, in the practice of the invention, the “in-between” images that are created and interpolated into the motion picture have the same level of image quality as the frames or images that were captured when the motion picture was originally photographed.

### BRIEF DESCRIPTION OF THE DRAWINGS

FIG. 1 shows five frames of motion picture film, lettered A through E. A vertical line is shown in each frame to illustrate movement of that line across the frame's field of view.

FIG. 2 shows nine frames; the five frames shown in FIG. 1, plus four other frames interpolated between them. Again, a vertical line is shown in each frame to illustrate movement of that line across the frame's field of view.

FIG. 3 shows a single frame, with lines representing pixels which form a portion of that frame, with an insert containing other lines, which represent a portion of the information in that frame that is treated according to a correction feature which forms part of the invention.

FIG. 4 shows the next frame in sequence, after the frame depicted in FIG. 3.

FIG. 5 shows a synthesized image to be projected after the image in FIG. 3 and before the image in FIG. 4, applying the correction feature which forms part of the invention. It should be noted that FIG. 5 is positioned between FIG. 3 and FIG. 4 on the drawing sheet, because the image represented in FIG. 5 would be inserted between the images represented by FIG. 3 and FIG. 4 in the practice of the invention.

It should also be noted that the drawings are presented in a highly simplified manner. The images which are enhanced in the actual practice of the invention are far more complex, due to both the inherent complexity of the images themselves and the motion vectoring process used in the enhancement of those images.

### DETAILED DESCRIPTION OF THE INVENTION

For enhancement of existing motion picture films to be shown at a frame rate of forty-eight frames per second of higher, the films are converted from analog to digital form by any means known in the conventional art. This step is not required for motion pictures which were photographed by digital means. In addition, if a motion picture was originally photographed for exhibition in a 35 mm film format, it is also necessary to add sufficient picture information to allow for reformatting onto the 70 mm film format without loss of picture quality. The process for this enhancement, as described previously, comprises suppression of grain, interpolation of synthesized images generated by motion vectoring, reduction of motion blur and sharpening of the resultant image.

Once the images are in digital form, a new image is generated for interpolation in a new frame, between each image of the original motion picture and its successive image. These “in between” frames contain new discrete images, generated by computer software. Retimer.RTM, developed by Reelviz, S. A., is suitable for this application. The advantage of Retimer.RTM lies in the manner in which the program generates the additional images for insertion into the image sequence. The program analyzes the movement of each individual pixel of information, through each sequence of images. It should be noted that the promotional literature for Retimer.RTM, as found on the company's web site, www.realviz.com, does not mention the application proposed in the present invention as suitable for the Retimer.RTM software.

As an example, consider an object (part of an image) depicted in a motion picture that appears to move from left to right across the screen upon which the motion picture is projected. In the conventional art of twenty-four frame-per-second presentation, the object would be seen twenty-four times each second, at different places on the screen. Had the movement of the object instead been captured at forty-eight frames per second, there would have been twice as many images of the object, and the object would appear to move approximately half as far from one image to the next than in the twenty-four frame-per-second example.

If the image of the object were to travel across the screen at a constant velocity, the newly-interpolated images would appear exactly half way between each pair of successive images in the original film. However, actual motion in real life entails accelerations and decelerations. The software calculates these accelerations and decelerations and generates new images that accurately depict the actual locations of all objects photographed, as they would have actually appeared if twice as many images had been originally captured than actually were.

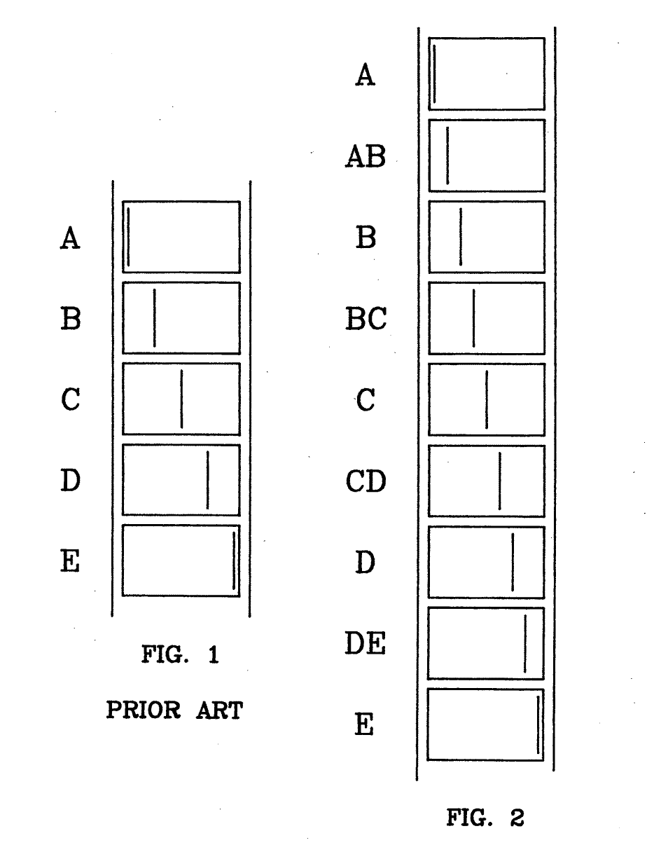

The effect of the interpolation and motion vectoring of these synthesized images can be seen by referring to the drawings. FIG. 1 shows five frames of a motion picture, lettered A through E. These frames represent a short sequence of an existing motion picture, of up to feature length. Instead of the live action that would typically be photographed, FIG. 1 shows a vertical line moving across the field of view represented by the frames in the drawing. In Frame A, the line is at the left side of the frame. It moves one quarter of the distance to the right at Frame B, one half of the distance to the right at Frame C, three quarters of the distance to the right at Frame D, and is located at the right side of the frame at Frame E. It should be noted that, the wider the screen onto which the motion picture is projected, the greater the amount of distance traveled between the positions of the line from one frame to the next. This disparity of displacement causes objectionable stroboscopic effects when conventional motion picture films are projected at twenty-four frames per second onto large theatrical screens. The larger the screen, the more objectionable the disparity of displacement becomes.

FIG. 2 shows the same sequence, after enhancement according to this invention. The same five frames from FIG. 1 are shown, but there are now added four new images, one placed between each of the original frames. Images AB, BC, CD and DE are new computer-generated images, designed to appear as if they were discrete images, the way they would look if they were photographed at double the original frame rate of photography (typically forty-eight frames per second, instead of twenty-four). This process is repeated for the entire length of the motion picture to be converted for exhibition. It should be noted that the position of the vertical line has moved approximately half the distance between images, compared to the smaller number of frames in FIG. 1. This reduced disparity of displacement from one image to the next cuts down significantly on the undesirable stroboscopic effects inherent in projection at conventional frame rates onto large theatrical screens. It should be noted that the illustration in the drawings is greatly simplified. Since the pixels that comprise actual images move at differing velocities from one image to the next, it is necessary to analyze the actual horizontal and vertical displacements of each pixel from one image to the next and synthesize interpolated images that precisely simulate the motion of the objects depicted. That is the process followed in the present invention.

The depiction of the lines in the newly-formed images is simplified for illustrative purposes. If the line in the illustration had been an actual object in a sequence of motion picture images, its placement on each interpolated image would be determined by the capability of the software to analyze motion, and would represent the actual position that the object would have assumed if it had been photographed at the actual frame rate of projection. The word “approximately” in the previous paragraph is critical. In reality, objects that appear to move across the motion picture screen accelerate and decelerate during the apparent journey. If an object actually moved at a constant velocity throughout its range of motion, then each object in the interpolated image would appear exactly half way between its position in the previous image and its position in the subsequent image. A method that produced interpolated images that appear to place all objects exactly half way between their locations in the previous image and the subsequent image would introduce errors; because it would fail to take into account the accelerations and decelerations of the objects as they were photographed.

For example, consider a ball thrown by a person seen on the left side of an image, to another person seen on the right side of the same image. The ball is thrown toward the recipient and with an upward component, so it rises in altitude, and then falls again, to reach an altitude at which the recipient can catch it. From the time the ball is thrown until it reaches its zenith, it is decelerating. Between any two time points, there is a forward (horizontal) component and an upward (vertical) component to the motion of the ball. Because the ball is moving toward the zenith of its trajectory, the vertical component of its motion decreases, resulting in a deceleration of upward motion. After the ball has reached its zenith, it begins to fall. At that time, the downward (vertical) component of its motion (caused by gravity) increases, as horizontal motion toward the recipient continues.

The software used in the present invention divides the motion of the objects (composed of a multiplicity of pixels) that form an image into intervals one twenty-fourth of a second long, corresponding to each frame of a motion picture. Within each such increment of motion, the software analyzes changing velocities of the objects in each image and determines the position of each such pixel at the midpoint in time between the previous image and the next image in sequence. Accordingly, the result is a highly accurate representation of the actual scene as it would look if it had actually been photographed at double the frame rate at which the images were originally photographed or produced. In other words, if a motion picture originally photographed at twenty-four frames per second is processed according to the invention described here, the result would look the way the same picture would have looked if it were actually photographed at forty-eight frames per second. In this manner, artifacts present at the lower frame rate would be suppressed. Moreover, the motion seen by the viewers of motion pictures enhanced according to this invention would see motion as it would actually appear, not a pseudo-motion synthesized by interpolating images exactly half-way between the previous and next image in the original motion picture, whether or not the “half-way” images accurately depicted the motion shown in the picture.

The software used in the practice of the invention can produce images that duplicate the scene as it actually would have appeared at the moment in time exactly halfway between each image and its successor by controlling each pixel individually. The software calculates motion vectors for each individual pixel or group of pixels, and estimates the actual displacement of each such pixel from one frame to the next. Each pixel is moved in the horizontal and vertical directions by the appropriate amount from one image to the synthesized image halfway between the previous image and the next one. The amount that each pixel is moved is determined by the recent history of displacement of that pixel over the run of recent previous images. In other words, the software analyzes the displacement of each pixel from frame to frame, taking into account the velocity of that pixel at any given frame (first time derivative of the displacement) and any changes in velocity that occur in the movement of that pixel (second time derivative of displacement). In that way, the displacement of every pixel is charted for each image of the entire motion picture. Given these motion vectors for each pixel, the software produces a precise “in between” image for interpolation between each image and its successive image of the original motion picture to replicate what the motion picture would have actually looked like if it had been photographed at double the frame rate at which it was originally photographed or produced. The software also permits manual adjustment of the location of any pixel or group of pixels to modify the image that the software presents as the simulated “in-between” image. Therefore, the user of the invention described can synthesize the entire set of interpolated images, pixel by pixel, to generate a motion picture that has twice as many images as the same motion picture originally had, with the “improved” picture appearing exactly as it would if it had originally been photographed or produced at the higher frame rate.

Sometimes the motion of a portion of the images in a sequence is so complex that the software used in the invention cannot follow it accurately to produce precise in-between images, free of artifacts. The invention described here includes a feature for correcting that deficiency. In the images that contain such complex motion, portions of those images are replaced by comparable portions of the images as they were originally photographed. This technique retains the original cinematic character for only the affected portions of those images. This correction does not detract from the overall audience perception of image dominance at the higher frame rate of exhibition, typically forty-eight frames per second, because viewers will not notice the correction. However, this method does prevent degradation of the portion of the affected images that would otherwise result from the software's inability to track complex motion accurately.

For example, consider an outdoor scene on a windy day. One of the characters is a woman who is wearing a plaid skirt or similar multicolored clothing with a complex pattern in the fabric. The skirt would blow in the wind, with the pixels representing the skirt moving very quickly and in directions that would appear random to the software that is generating new images for interpolation. Without the correcting feature of the invention, that portion of the image (the skirt blowing in the wind) would appear muddled, and the software would ordinarily consider it to be corrupted. In the practice of the invention, the specific portions of such affected images would be treated differently from all other components of the same images. In only the selected portions, the prime feature of the image synthesis would be over-written and bypassed, and those portions of the image would be omitted from the image-synthesis feature, which would still be applied to the rest of the image as actually captured on film or by digital means.

In the example, the woman's skirt would be specifically selected to be bypassed by the image-synthesis feature, which would still be applied to the rest of the image. The invention makes redundant use of frames as originally photographed to depict only the skirt. This corrective alteration does not detract from the enhanced 48-fps effect for the image as a whole. Since only a portion of the affected images are segregated and specially-treated in the practice of the invention, the audience would not notice a redundancy, which is restricted to those portions of the affected images. The motion of the skirt would appear smoother than it would have if the images containing it were treated in the conventional manner; i.e. if the rapid and complex motion of the fabric had been treated the same as the rest of the image.

The feature, selectively treating parts of images while refraining from treating the rest of each of those images, is a vital feature of the invention, and was not anticipated in the prior art.

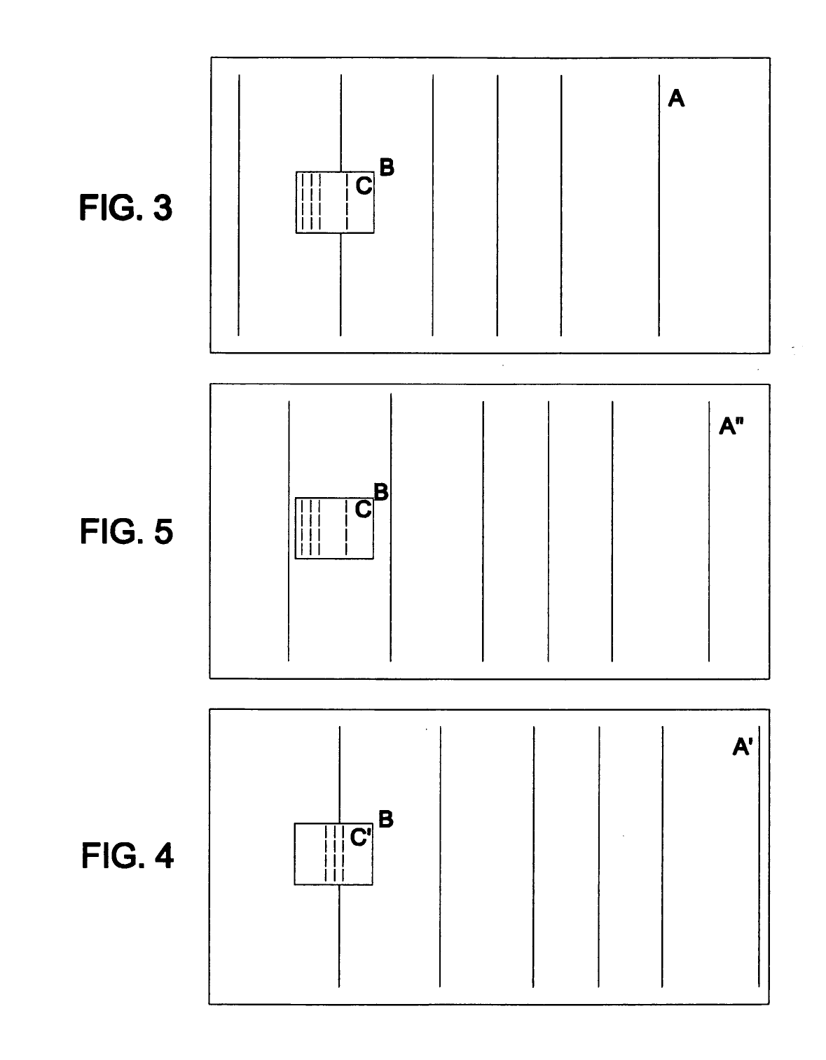

The application of this correcting feature can be seen in the drawings, specifically FIGS. 3, 4 and 5. The drawings are highly simplified to illustrate a principle. Since the motion to be treated according to the invention is so complex that special treatment is necessary, it is impossible to depict the motion to be treated in simple drawings.

Referring to FIG. 3, a series of lines A represent pixels that form a small part of the image on a frame from a motion picture. In practice, the motion depicted in an actual motion picture image would be vastly more complex. A square area B represents a portion of the image whose motion is so complex that the software used in the practice of the invention would be incapable of accurately reproducing the location of each pixel of that image portion in the location where it would have appeared exactly half-way in time between one original motion picture frame and the next. In practice, the area shown as square would be an irregular shape, with straight and curved edges in different places; perhaps even discontinuous in nature. Dotted lines C represent a few pixels that form a small part of the image in area B. In practice, the motion depicted in a portion of an actual film frame would be vastly more complex.

FIG. 4 shows the next frame in a motion picture, after the frame shown in FIG. 3. In conventional motion picture art, the frame represented in FIG. 4 would have been photographed one twenty-fourth of a second later than the frame represented in FIG. 3. The positions of lines A′ and dotted lines C′ are different than they were in FIG. 3.

FIG. 5 represents an image to be placed half way between the image represented by FIG. 3 and the image represented by FIG. 4. It is placed between FIG. 3 and FIG. 4 on the drawing sheet to mark its position as an interpolated image, synthesized according to the invention and placed between the images from the original motion picture, depicted in FIG. 3 and FIG. 4.

Without the correction feature disclosed here, none of the image would be singled out for special treatment, and the lines would appear as if FIG. 5 represented their location half-way in time between the frame represented in FIG. 3 and the frame represented in FIG. 4. Because of the complexity of the motion occurring in Area B, the pixels within Area B are treated differently than those which comprise the rest of the image outside Area B, so that the entire image appears to be free of unnatural artifacts.

In the practice of the invention, the pixels within Area B are segregated for special treatment and specifically not moved from the positions they held in the image represented by FIG. 3. Therefore, FIG. 5 contains lines outside Area B at positions designated A″, while lines inside area B remain at positions designated C; the same as in FIG. 3. Area B, with its complex motion, would appear corrupted to the recognition feature of the software used in the practice of the invention. Taking this “corrupted” area and seamlessly replacing it with image components from the original frames produces an appearance which is internally and externally consistent as viewed.

With this feature, the result is that most of an image containing a component of complex motion is treated in the normal manner of this invention, which delivers the appearance of a motion picture that had originally been photographed at double the actual rate of original image capture, typically forty-eight frames per second, instead of twenty-four. Image components whose motion is highly complex are specifically treated to give the impression of image capture at the higher frame rate, typically forty-eight frames per second.

The specially-treated image portions comprise a small percentage of the total number of pixels in the entire motion picture, so viewers would not notice that such treatment had occurred. It is counter-intuitive to expect that the portion of an image that contains highly complex motion (the example used here is a woman's plaid summer skirt, made of lightweight material, blowing in the breeze) should be treated the same as the rest of the image, in which motion is not so complex, for the synthesis of “in-between” images for the entire motion picture. Yet, this is what was taught by Cok and other inventors of the prior art. It is not feasible to treat the portions of images in which motion is so complex the same as all other image components, because each pixel in these special image components moves so quickly that the software is unable to locate each such pixel precisely enough to generate an “in-between” image that depicts actual motion accurately. Attempting to use the software in the conventional manner to analyze such pixels would not yield as desirable a result as singling them out for special treatment. The enhanced result that the special-treatment feature delivers is the primary object of this invention.

Because the software used in the practice of the invention treats each pixel as a vector which moves and can change direction with each frame, it can also recognize when motion is so complex that the software cannot effectively perform its function for specific image components in certain frames. This recognition allows automatic operation of the special-treatment process for these image components. When the software recognizes such complex motion, it treats those image components in a special manner by repeating only those components from the previous original image as part of the new “in-between” image that it is generating. The rest of the new image is generated according to the conventional use of the software as described here.

The novel use of the software in the practice of the invention is to detect motion that is too complex for the software to handle in the conventional manner, treat that motion as an error, dissect out portions of images that constitute such an error, and correct the error in the “in-between” images that it generates. Since the “error” constitutes only part of the affected images and those images constitute only a small portion of the entire motion picture that is enhanced according to the invention, the high-impact effect on the audience is delivered without undesirable artifacts.

If motion is so complex that the above-mentioned correction feature does not work, such complexity will still not defeat the primary object of the invention. For the few affected frames, the entire image can be repeated only during the duration of the overwhelming complexity of motion, so the audience would not notice any artifacts caused by this emergency correction method. Alternatively, such extremely complex motion can be dissected frame-by-frame, using software designed for processing single images and known in the art. The process is extremely expensive and labor-intensive at the post-production stage. Therefore, it is only suitable for the invention described here in an emergent situation where only a few images are affected.

In the practice of the invention, the resulting images are free of defects when they are exhibited to the audience. This is critical for contemporary audiences in a motion picture theater, since viewers would notice such a defect as strobing or another objectionable artifact. With only parts of a few images affected during the course of a motion picture, this will not occur.

The resulting “film” in digital form is then either projected digitally according to methods known in the art, or it is converted back to an analog “film” format for projection at forty-eight frames per second. In the preferred embodiment of the invention, the 70 mm theatrical film format is used, with five perforations per frame, with the image on the film stretched anamorphically to the equivalent of an eight-perforation frame. This creates a taller image and one with a more “square” aspect ratio than the 2.21 to 1 that is normally found in the 70 mm format with five perforations per frame. Therefore, the motion pictures enhanced according to this invention will utilize more screen height than does the conventional 70 mm (five-perforation) film format, which would deliver a “letterbox” look. The films prepared for exhibition according to this invention can be stored on 70 mm film in the five-perforation format, anamorphically compressed. The aspect ratio can be changed by anamorphic expansion upon projection.

In the film-exhibition application of the present invention, projection takes place at forty-eight frames per second, and the use of a double-bladed shutter on the projector delivers the display of ninety-six impressions per second to the viewers of the film. The invention delivers forty-eight discrete images to the audience every second during the entire presentation. As perceived by the viewers of the film, the forty-eight images presented every second appear to fully depict the scene as if it were actually photographed at forty-eight frames per second. Projection must be accomplished at forty-eight frames per second or a higher frame rate (or its digital equivalent) to achieve the desired result. Either analog or digital projection methods can be used in accordance with this invention.

The use of a double-bladed shutter for film projection at forty-eight frames per second further improves the quality of the images delivered to the audience, since it allows for a significantly higher light level than is available with twenty-four frame-per second projection (forty-eight impressions per second with a double-bladed shutter). This results in higher image contrast and improved color rendition. In addition, light levels in excess of sixteen footlamberts are achievable without projection flicker, as compared to the conventional flicker threshold of twelve to sixteen footlamberts. This increased level of screen brightness is available with the use of a double-bladed shutter, because the delivery of ninety-six impressions per second eliminates flicker and other artifacts sufficiently to allow the brighter light level without objectionable artifacts.

The same light brightness levels are also obtainable with digital exhibition in the practice of the invention, which is also compatible with digital projection methods known in the art. The DLP digital projector developed by Texas Instruments is suitable for commercial theatrical exhibition of the films enhanced according to the invention.

For film projection, the benefits obtained through the use of a double-bladed shutter at forty-eight frames per second can be achieved through the use of a projector capable of accomplishing pulldown in an interval of five milliseconds or less; twice as fast as can be done by a conventional Geneva-movement projector. This technique was previously disclosed by Weisgerber in U.S. Pat. No. 5,627,614 (1998).

The invention described delivers enhanced versions of films produced in the 35 mm format by augmenting the information packing density associated with the 35 mm format, to the level associated with the 70 mm film format. In effect, the method described here adds more information to existing films, so the audience will perceive more visual information than was placed onto the original film in the original production. While it is envisioned that the invention described will be used primarily with motion pictures produced through film methods known in the art, the invention is also suitable for enhancement of motion pictures produced through 24P digital production acquisition.

The beneficial effect of this invention can also be imparted selectively to specific scenes or sequences of a motion picture. When the user of the invention desires to have the audience perceive the full impact available, the invention is used to enhance only those specific scenes or sequences. For other scenes or sequences, the original frames are double-frame printed or repeated by digital means for the equivalent effect. This allows the intentional retention of the artifacts inherent in double-frame printing, which the present invention is designed to eliminate. Thus, these artifacts can be either eliminated or retained for any specific scene or sequence of a motion picture. As with the previous Weisgerber inventions, the benefit can be imparted and removed selectively when enhancing a previously-produced motion picture.

Certain images may also contain too much motion during a short period to allow the software to keep accurate track of the location of every given pixel of every image, which would defeat the ability of the software to produce an exact new “in-between” image for high-frame-rate projection. In that event, the invention also allows for presentation of appropriate images to the audience, despite this obstacle.

The present invention also allows previously-produced stock footage (often stored in film libraries and film studio collections) to be enhanced in a cost-effective manner for use in the production of new motion pictures. By using the invention described, such “stock” film sequences (photographed at twenty-four frames per second) can be converted to appear as if they had been photographed at forty-eight frames per second, with the motion vectoring feature simulating the look that would have been captured by actual 48-fps photography. Such “stock” sequences can then be used in connection with the production of new motion pictures, with no loss of image quality due to the use of images that had been recorded in an “old” film format and through an “old” method.

By using digital enhancement methods and computerized image creation to add sufficient information to each image to accommodate the 70 mm format or its digital equivalent, as well as to generate new images to fit between each of the previously-photographed images, conversion can be accomplished efficiently, without loss of light, image clarity or resolution associated with optical conversion methods. The method described reduces grain and improves apparent resolution, resulting in an “immersive” presentation, which delivers the image clarity associated with real life.

The invention allows motion picture theatrical audiences to view a motion picture that was originally produced at twenty-four frames per second without the artifacts associated with that frame rate: grain, jutter, strobescopic effects and motion blur. Elimination of these objectionable artifacts associated with the original frame rate in which the motion picture was produced adds a dimensionality to the view delivered to the audience. The additional images imparted in the practice of the invention help to deliver a more immersive experience than is available at the lower frame rate. The result is a presentation that simulates a three-dimensional look, without the need to spend the large amounts of money needed for the production or post-production of motion pictures in 3-D formats.

The invention described permits the showing of a previously-produced motion picture with the level of picture clarity consistent with new motion picture production. Contemporary standards now render the conventional frame rate of twenty-four frames per second inadequate to sufficiently suppress undesirable artifacts such as stroboscopic effects. With the actual analysis of motion vectors between each frame, however, the interpolated images developed in accordance with this invention eliminate these effects by duplicating the motion that the camera would have actually captured if it had operated at the higher frame rate in the first place.

In addition, the amount of magnification now used in the motion picture art requires the level of image quality consistent with the practice of this invention. Magnifying an image on 35 mm film to a screen larger than forty-five feet wide only displays the shortcomings of the 35 mm film format. Use of the 70 mm format delivers a high-quality presentation on screens up to eighty feet wide. On such large screens, interpolation of motion cannot be acceptably smooth for any fast motion projected at twenty-four frames per second. The displacement between frames is simply too large. With the present invention, the actual displacement of an object on the screen is calculated, and objects are shown as being in the correct location on every synthesized “in-between” image. This result is not available through other means.

Another collateral benefit of this invention is that the dynamic image enhancement described also reduces grain, sharpens images and produces an image with a superior appearance on large theatrical screens, compared to those available through conventional means. With conventional film technology, there is more objectionable grain and lower apparent resolution than with the present invention.

Digitizing the film images before engaging in the enhancement process improves the impact of a theatrical motion picture presentation without sacrificing picture quality. This reduction of picture quality is inherent in optical enlargement of films originally produced in the 35 mm film format and converted to the 70 mm film format. In effect, the change in formats is done much more efficiently with digitized images than with conventional film images. In addition, the impartation of “in-between” images that effectively produce the actual appearance of an image that would have been photographed between each pair of images in the original motion picture is only available through use of the invention described here.

While the basic invention and the preferred embodiment have been described, this description should be thought of as illustrative and not limiting. Other frame rates, such as fifty or sixty frames per second, can be used. So can other film formats. Digital exhibition formats and methods are also suitable for the invention, in addition to film formats and methods. Other embodiments are also possible, and they should be thought of as lying within the scope of the invention.

The invention claimed is:

1. A method for converting previously-produced motion pictures, whether photographed on film or by digital means, for projection at a higher frame rate than that in which such motion pictures were originally produced, to theatrical audiences, with the effect of improving the presentation of such motion pictures to the members of such audiences, the method comprising: converting each of the images in said motion pictures to a digital format, if the motion picture to be enhanced was originally photographed on film; formulating images which accurately depict the scene of the motion picture at a time interval half way between the appearance of one such image and the next successive image in said motion picture; interpolating these transitional images between each original image of said motion picture and its successive image; converting said motion picture to a film or digital form suitable for projection; and projecting such motion picture at double the frame rate at which it was originally produced.

2. The method as in claim 1, in which said interpolated images are of comparable quality to the original frames which comprise said motion picture, whether said motion was originally photographed on film or by a digital image capture method.

3. The method as in claim 2, in which said interpolated images are generated using computerized imaging techniques.

4. The method as in claim 3, in which said interpolated images are generated using software which analyzes the apparent motion of each pixel of each image actually photographed during the preparation of such motion picture, and generates new images to depict the actual motion of each of said pixels, with the result that each of said synthesized images would appear identical to the look that it would have had if said motion picture had actually been photographed at the same speed at which it is projected.

5. The method as in claim 4, in which motion pictures originally produced for projection at twenty-four images per second are converted according to the method described for projection at forty-eight images per second.

6. The method as in claim 5, in which motion pictures enhanced according to the method described are exhibited to audiences in the 70 mm film format or its digital equivalent.

7. The method as in claim 6, in which projection of such motion pictures in film format is accomplished through a double-bladed shutter.

8. The method as in claim 4, in which some scenes or sequences of a motion picture are enhanced according to the method described, while other scenes or sequences of the same motion picture are not enhanced and retain the look they had when they were originally photographed.

9. The method as in claim 4, in which in which previously-photographed motion picture sequences are enhanced, for insertion into new motion pictures as part of such new motion pictures.

10. The method as in claim 4, further comprising a means for generating said interpolated images when the motion originally captured is sufficiently complex as to prevent accurate use of the method described in claim 4 for the entirety of every image of the original motion picture that is subjected to the enhancement method according to claim 4.

11. The method as in claim 10, in which special treatment is given to selected components of certain images of said motion picture, which contain visual information of such complexity that the software used in the practice of the invention would be unable to follow the motion of each pixel in such exceptional image components sufficiently to ascertain the precise location for each such pixel and then synthesize an image for those components accurately, for precise interpolation between original images of said motion picture.

12. The method as in claim 11, in which selection and treatment of such image components for special treatment is accomplished through recognition by the software used in the invention that certain pixels of certain images of the original motion picture are incapable of being processed in an appropriate manner under the normal operation of such software, along with retention of the components of the previous original image in such portions of said; such recognition and retention being executed specifically for said image components, while all other images and image components are treated according to the method of claim 4.

13. The method as in claim 12, in which nearly all of a motion picture frame is enhanced for projection at double the frame rate at which said motion picture was originally photographed or otherwise recorded, while certain components of certain images are singled out for the bypassing of such enhancement and appear as they were originally photographed or otherwise recorded.

14. The method as in claim 13, in which motion pictures originally photographed at twenty-four frames per second are enhanced and projected at forty-eight frames per second, with the exception that certain components of certain images are specially treated to appear as they were originally photographed, through selective repetition of those components of the original image.

15. The method as in claim 14, whereby said method is executed automatically, under the control of said software and through the feature of said software that recognizes the motion trajectory of each pixel of each image of the original motion picture that is enhanced according to the invention.

16. A method for converting previously-produced motion pictures for exhibition to theatrical audiences at double the frame rate at which said motion pictures were originally photographed, for delivery of a heightened impact upon the members of said audiences, where the improvement comprises the use of computerized image-generating techniques to produce transitional images; such techniques evaluating the motion of each pixel of each of the images in the original motion picture, and such transitional images being inserted between each of the original images of said motion picture, to accurately depict the exact appearance that said previously-produced motion picture would have had if it had originally been photographed at the frame rate at which it is projected to said audiences.

17. The motion picture as in claim 16 which was photographed or otherwise originally recorded at twenty-four frames or images per second and enhanced for exhibition at forty-eight frames or images per second.

18. The method as in claim 17, in which motion pictures originally photographed in a 35 mm film format are enhanced for exhibition in a 70 mm film format or its digital equivalent.

19. The method as in claim 14, in which said method is executed automatically, under the control of said software and through the feature of said software that recognizes the motion trajectory of each pixel of each image of the original motion picture that is enhanced according to the invention.

20. A method for enhancing motion pictures in film or digital format for exhibition to audiences at double the frame rate at which such motion pictures were originally photographed, using computerized means for generating additional images for interpolation between each of the original images of said motion pictures; with an additional correcting method also being applied only to components of images which depict motion of sufficient complexity that such such enhancement method cannot generate appropriate transitional images of such image components; the method comprising: detecting such complex motion in specific components of certain images, treating such components as erroneous information, selecting such erroneous information for special treatment, and replacing such erroneous components with the comparable components taken the previous image from the original motion picture.
